(19) United States
(12) Patent Application Publication
(10) Pub. No.: US 2009/0327690 A1
(43) Pub. Date: Dec. 31, 2009

(54) Methods and Systems for Facilitaing Secure Communication

(76) Inventors: Bjorn Gustaf Landfeldt, New South Wales (AU); Jahan Ara Hassan, New South Wales (AU)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 11/992,465

(22) PCT Filed: Sep. 7, 2006
(86) PCT No.: PCT/AU2006/001303

§ 371 Date: Sep. 3, 2009

(30) Foreign Application Priority Data
Sep. 23, 2005 (AU) 2005905258
Nov. 18, 2005 (AU) 2005906429

(51) Int. Cl. H04L 9/00; H04L 9/08

(52) U.S. Cl. 713/150; 380/278

(57) ABSTRACT

A method of facilitating secure communication, the method comprising the steps of obtaining a cryptographic key, identifying at least one trusted computing device and sending the cryptographic key to the trusted computing device.

### FIELD OF THE INVENTION

The present invention relates generally to the field of computer security, and more particularly—but by no means exclusively—to the field of authenticating a computer.

### BACKGROUND OF THE INVENTION

The development of wireless networking technologies, (such as IEEE 802.11) allows users of portable computing devices (such as laptops) to quickly and easy obtain network access. For example, many coffee shops now support wireless ‘hotspots’, which enable portable computer users to connect to the Internet via their computer's wireless networking card. To guard against unauthorised network access many of today's wireless networking technologies have been augmented with security features. For example, IEEE 802.11i incorporates the use of IEEE 802.1X port-based authentication.

While many of the security features of today's wireless networking technologies provide robust network security, the security features have by and large been designed with non-time sensitive data transfers in mind. Thus, many of the security features may prove to be problematic when used in conjunction with time sensitive data such as audio and/or video. More specifically, it has been shown that the handoff procedure associated with IEEE 802.1X port-based authentication can potentially suspend data transfer for up to 1.1 seconds while handoff authentication takes place. Delaying the transfer of audio and/or video data for up to 1.1 seconds can result in a serious user perceivable degradation in the reproduced audio and/or video.

Numerous attempts have been made to reduce the data transfer delay associated with handoff in a wireless network. These attempts include, for example, pre-authentication and proactive key distribution. While these attempts have been able to reduce the data transfer delay associated with a handoff, the attempts do have some drawbacks. For instance, they assume the various wireless access points (hotspots) are under the same administrative domain. There are many situations where the wireless access points are not under the same administrative domain and thus may not be used in such a scenario. An example of where access points are not under the same administrative domain is the domestic wireless routers that are commonly used within an individual's residence. These domestic wireless routers are sometimes referred to as residential gateways.

### SUMMARY OF THE INVENTION

According to a first aspect of the present invention there is provided a method of facilitating secure communication, the method comprising the steps of:

obtaining a cryptographic key;

identifying at least one trusted computing device; and

sending the cryptographic key to the trusted computing device.

An advantage of an embodiment of the first aspect of the present invention is that it has the potential of reducing the handoff delay that can be associated with the security features built into existing wireless networking technologies. More specifically, unlike existing techniques for reducing the handoff delay the embodiment of the first aspect can be used in the situation where the various wireless access points are not under the same administrative domain. The ability to be used in the situation where the wireless access points are under different administrative control stems from the ability to identify the at least one trusted computing device.

Preferably, the method further comprises the steps of:

obtaining a first datum; and

sending the first datum to a user computing device that is arranged to send the first datum to the trusted computing device in order to obtain the cryptographic key therefrom.

In an embodiment of the first aspect sending the first datum to the user computing device enables the user computing device to avoid undergoing full authentication when handing-off to a new wireless access point (router). On receiving the first datum the new wireless access point will realise the user computing device has already undergone full authentication and therefore the new wireless access point and the user computing device need only undergo minimal authentication. Thus, avoiding the handoff delay associated with full authentication.

Preferably, the first datum comprises:

an identifier of the first datum; and

an identifier of the trusted computing device.

Preferably, the step of obtaining the first datum comprises the step of processing an identifier of the user computing device, an identifier of a trusting computing device, and a timestamp in order to obtain the identifier of the first datum.

In an embodiment of the first aspect of the invention the identifier of the user computing device, the identifier of the trusting computing device and the timestamp are used to generate a unique first datum.

Preferably, the step of sending the first datum comprises the step of using a first secure link to send the first datum to the user computing device.

In an embodiment of the first aspect of the present invention the secure link provides an added level of security against an authorised person intercepting the first datum as it is transferred to the user computing device.

Preferably, the step of obtaining the cryptographic key comprises the step of communicating with an authenticating computing device to obtain the cryptographic key.

Preferably, the step of sending the cryptographic key comprises the steps of:

obtaining a second datum that comprises: the identifier of the first datum; the identifier of the user computing device; the cryptographic key; and a digital signature of the trusting computing device; and

sending the second datum to the trusted computing device.

In an embodiment of the first aspect of the present invention sending the second datum to the trusted computing device enables, for example, the trusted computing device to authenticate the authenticity of the cryptographic key by using the digital signature.

Preferably, the step of sending the second datum comprises the step of using a second secure link to transfer the second datum to the trusted computing device.

In an embodiment of the present invention the second secure link is used as a safeguard against an unauthorised person intercepting the second datum when it is transferred to the trusted computing device.

Preferably, the method further comprises the step of sending the cryptographic key to the user computing device in accordance with a predetermined protocol.

Preferably, the trusted computing device and the trusting computing device are each in the form of a wireless router.

According to a second aspect of the present invention there is provided a method of facilitating secure communication, the method comprising the steps of:

obtaining a cryptographic key from a trusting computing device;

receiving a first datum from a user computing device; and

sending the cryptographic key to the user computing device in response to receiving the first datum.

Preferably, the step of obtaining the cryptographic key comprises the steps of:

receiving from the trusting computing device a second datum that comprises: an identifier of the first datum; an identifier of the user computing device; the cryptographic key; and a digital signature of the trusting computer; and

retrieving the cryptographic key from the second datum.

Preferably, the step of receiving from the trusting computing device comprises the step of using a first secure link to receive the second datum.

Preferably, the step of sending the cryptographic key comprises the step of sending the cryptographic key in accordance with a predetermined protocol.

Preferably, the first datum comprises:

an identifier of the first datum; and

an identifier of a trusted computing device.

Preferably, the trusted computing device and the trusting computing device are each in the form of a wireless router.

According to a third aspect of the present invention there is provide a method of facilitating secure communication, the method comprising the steps of:

receiving a first datum from a trusting computing device;

sending the first datum to a trusted computing device; and

receiving a cryptographic key from the trusted computing device in response to sending the first datum to the trusted computing device.

Preferably, the method further comprises the steps of:

determining a resource availability of the trusted computing device; and

performing the step of sending the first datum to the trusted computing device if is determined that the resource availability does not exceed a predetermined level.

Preferably, the step of receiving the first datum comprises the step of using a secure link to receive the first datum from the trusted computing device.

Preferably, the first datum comprises:

an identifier of the first datum; and

an identifier of the trusted computing device.

Preferably, the method comprises the step of processing the identifier of the trusted computing device in order to perform the step of sending the first datum to the trusted computing device.

Preferably, the step of receiving the cryptographic key comprises the step of receiving the cryptographic key in accordance with a predetermined protocol.

Preferably, the trusted computing device and the trusting computing device are each in the form of a wireless router.

According to a fourth aspect of the present invention there is provided a system for facilitating secure communication, the system comprising a processing means arranged to perform the steps of:

obtaining a cryptographic key,

identifying at least one trusted computing device; and

sending the cryptographic key to the trusted computing device.

Preferably, the processing means is further arranged to perform the steps of:

obtaining a first datum; and

sending the first datum to a user computing device that is arranged to send the first datum to the trusted computing device in order to obtain the cryptographic key therefrom.

Preferably, the first datum comprises:

an identifier of the first datum; and

an identifier of the trusted computing device.

Preferably, the processing means is arranged such that the step of obtaining the first datum comprises the step of processing an identifier of the user computing device, an identifier of a trusting computing device, and a timestamp in order to obtain the identifier of the first datum.

Preferably, the processing means is arranged such that the step of sending the first datum comprises the step of using a first secure link to send the first datum to the user computing device.

Preferably, the processing means is arranged such that the step of obtaining the cryptographic key comprises the step of communicating with an authenticating computing device to obtain the cryptographic key.

Preferably, the processing means is arranged such that the step of sending the cryptographic key comprises the steps of:

obtaining a second datum that comprises: the identifier of the first datum; the identifier of the user computing device; the cryptographic key; and a digital signature of the trusting computing device; and

sending the second datum to the trusted computing device.

Preferably, the processing means is arranged such that the step of sending the second datum comprises the step of using a second secure link to transfer the second datum to the trusted computing device.

Preferably, the processing means is further arranged to perform the step of sending the cryptographic key to the user computing device in accordance with a predetermined protocol.

Preferably, the trusted computing device and the trusting computing device are each in the form of a wireless router.

According to a fifth aspect of the present invention there is provided a system for facilitating secure communication, the system comprising a processing means arranged to perform the steps of:

obtaining a cryptographic key from a trusting computing device;

receiving a first datum from a user computing device; and

sending the cryptographic key to the user computing device in response to receiving the first datum.

Preferably, the processing means is arranged such that the step of obtaining the cryptographic key comprises the steps of:

receiving from the trusting computing device a second datum that comprises: an identifier of the first datum; an identifier of the user computing device; the cryptographic key, and a digital signature of the trusting computer; and

retrieving the cryptographic key from the second datum.

Preferably, the processing means is arranged such that the step of receiving from the trusting computing device comprises the step of using a first secure link to receive the second datum.

Preferably, the processing means is arranged such that the step of sending the cryptographic key comprises the step of sending the cryptographic key in accordance with a predetermined protocol.

Preferably, the first datum comprises:

an identifier of the first datum; and

an identifier of a trusted computing device.

Preferably, the trusted computing device and the trusting computing device are each in the form of a wireless router.

According to a sixth aspect of the present invention there is provided a system for facilitating secure communication, the system comprising a processing means arranged to perform the steps of:

receiving a first datum from a trusting computing device;

sending the first datum to a trusted computing device; and

receiving a cryptographic key from the trusted computing device in response to sending the first datum to the trusted computing device.

Preferably, the processing means is further arranged to perform the steps of:

determining a resource availability of the trusted computing device; and

performing the step of sending the first datum to the trusted computing device if is determined that the resource availability does not exceed a predetermined level.

Preferably, the processing means is arranged such that the step of receiving the first datum comprises the step of using a secure line to receive the first datum from the trusted computing device.

Preferably, the first datum comprises:

an identifier of the first datum; and

an identifier of the trusted computing device.

Preferably, the processing means is further arranged to perform the step of processing the identifier of the trusted computing device in order to perform the step of sending the first datum to the trusted computing device.

Preferably, the processing means is arranged such that the step of receiving the cryptographic key comprises the step of receiving the cryptographic key in accordance with a predetermined protocol.

Preferably, the trusted computing device and the trusting computing device are each in the form of a wireless router.

According to a seventh aspect of the present invention there is provided a computer program comprising at least one instruction, which when executed by a computing device causes the computing device to perform the method according to any one or more of the first, second and third aspects of the present invention.

According to an eighth aspect of the present invention there is provided a computer readable medium comprising the computer program according to the seventh aspect of the present invention.

### BRIEF DESCRIPTION OF THE DRAWINGS

Notwithstanding any other embodiments that may fall within the scope of the present invention, an embodiment of the present invention will now be described, by way of example only, with reference to the accompanying figures, in which:

FIG. 1 is a schematic diagram of a system including an embodiment of the present invention;

FIG. 2(a) is a flow chart of various steps performed by the system of FIG. 1 in accordance with an embodiment of the present invention;

FIG. 2(b) is a flow chart of various steps performed by the system of FIG. 1 in accordance with an embodiment of the present invention;

FIG. 2(c) is a flow chart of a step performed by the system of FIG. 1 in accordance with an embodiment of the present invention;

FIG. 3 is a message used in the system of FIG. 1 in accordance with an embodiment of the present invention;

FIG. 4 is a message used in the system of FIG. 1 in accordance with an embodiment of the present invention;

FIG. 5 is a flow chart of various steps performed by the system of FIG. 1 in accordance with an embodiment of the present invention; and

FIG. 6 is a flow chart of various steps performed by the system of FIG. 1 in accordance with an embodiment of the present invention.

### AN EMBODIMENT OF THE INVENTION

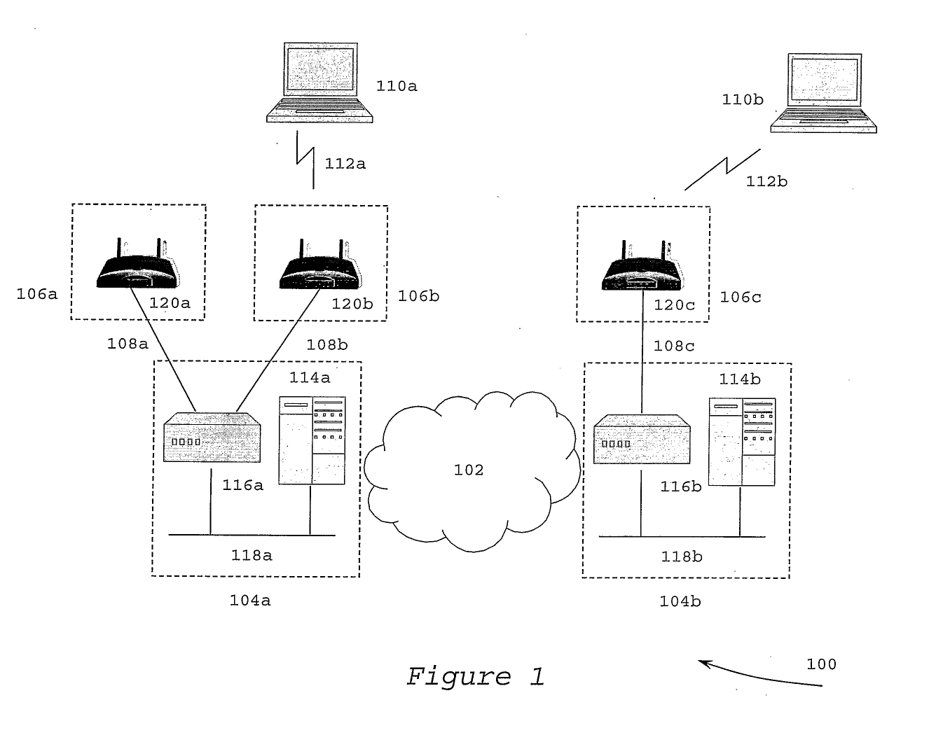

With reference to FIG. 1, a system 100 including an embodiment of the present invention comprises: a computer network 102; a plurality of primary network access points 104 that are associated with the network 102; a plurality of secondary access points 106 that are connected to the primary access points 104 via physical data links 108; and a plurality of user computing devices 110 that can connect to the secondary access points 106 via wireless links 112.

The computer network 102 is in the form of a public access packet switched network, and more specifically is in the form of the Internet. Consequently, persons skilled in the art will readily appreciate that the computer network 102 comprises numerous routers/switches (not illustrated in the figures) that are interconnected via high speed optical data links (also not shown in the figures). The routers/switches support at least one Internet Protocol (IP) based routeing protocol, such as the Routeing Information Protocol (RIP) or Open Shortest Path First (OSPF), so that they can route/switch IP data packets between each other.

As persons skilled in the art will readily appreciate, each primary network access point 104 (which is typically operated by an internet service provider) comprises one or more computer servers 114 each of which is loaded with software that enables the server 114 to operate as a web server, authentication server and mail server. The computer servers 114 are connected to the computer network 102 by a high speed physical data link (which is not shown in the figures). In addition to the computer servers 114 each primary network access point 104 comprises a remote access concentrator 116 that is coupled to the physical data links 108a. The remote access concentrator 116 is capable of sending and receiving IP data packets to and from one of the secondary access points 106 via the associated physical data link 108. Each primary network access point 104 also comprises a local area network 118, to which the computer servers 114 and remote access concentrator 116 are electrically coupled. The computer servers 114 and the remote access concentrator 116 are arranged to exchange IP data packets with each other via the local area network 118.

Each secondary network access point 106 comprises a wireless router/switch 120 that supports the IEEE 802.11 standard. The wireless routers/switches 120 are typically located in different premises; for example, houses or offices. Furthermore, the wireless routers/switches 120 are also typically under different administrative control; that is, the system administrator responsible for any one of the wireless routers/switches 120 is generally not responsible (or has the authority) for any of the other wireless routers/switches 120. Each wireless router/switch 120 is electrically coupled to one of the physical data links 108 so that it can exchange IP packets, via the associated data link 108, with the remote access concentrator 116 of the associated primary access point 104. As persons skilled in the art will appreciate the primary network access points 104 enable the wireless routers/switches 120 to exchange data via the computer network 102.

Each user computing device 110 is in the form of a laptop computer that has a wireless networking card that conforms to the IEEE 802.11 standard. The wireless networking card allows the laptop computer to exchange IP data packets with a wireless router/switch 120 of a secondary network access point 106 via a wireless link 112. As persons skilled in the art will readily appreciate, the user computing devices 110 rely on the wireless router/switch 120 of a secondary network access points 106 to exchange IP data packets via the computer network 102. As indicated previously, the wireless routers/switches 120 of the secondary network access points 106 rely on the primary network access points 104 to exchange IP data packets (which may have been created by the user computing devices 110) via the computer network 102. Each user computing device 110 is such that it is relatively portable, which potentially allows the user computing devices 110 to gain access to the computer network 102 via any of the secondary network access points 106. This characteristic is sometimes referred to as roaming.

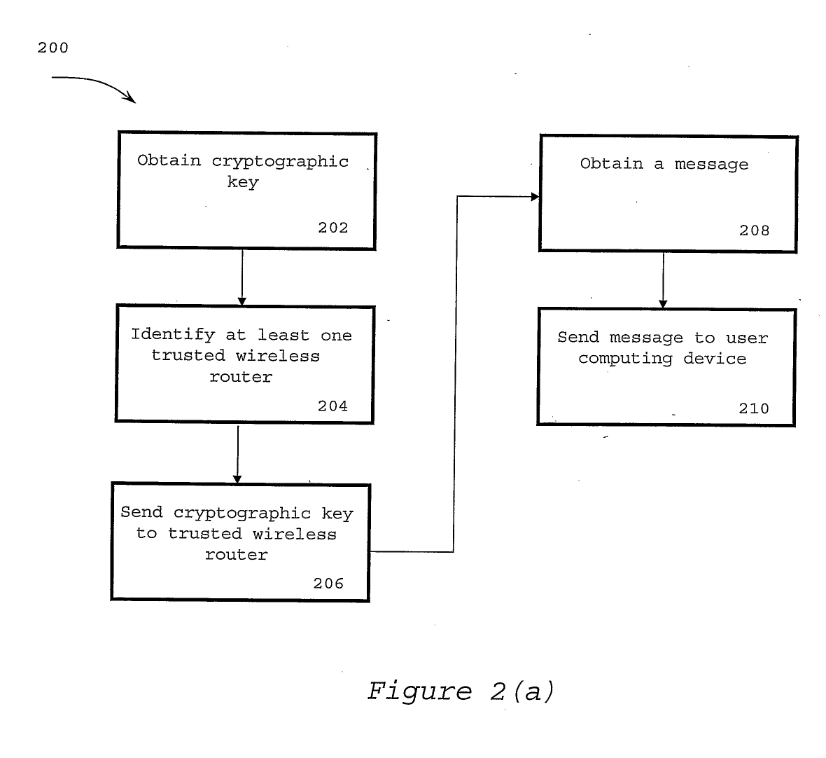

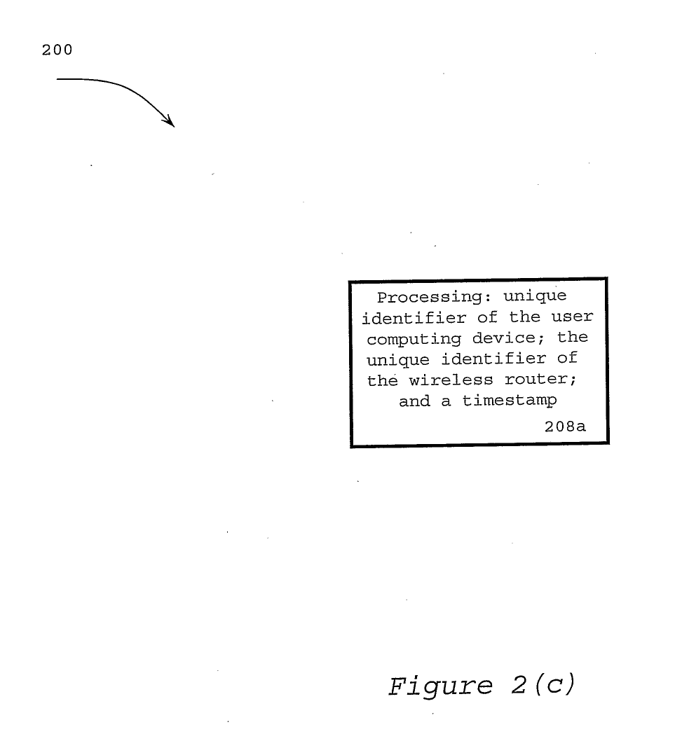

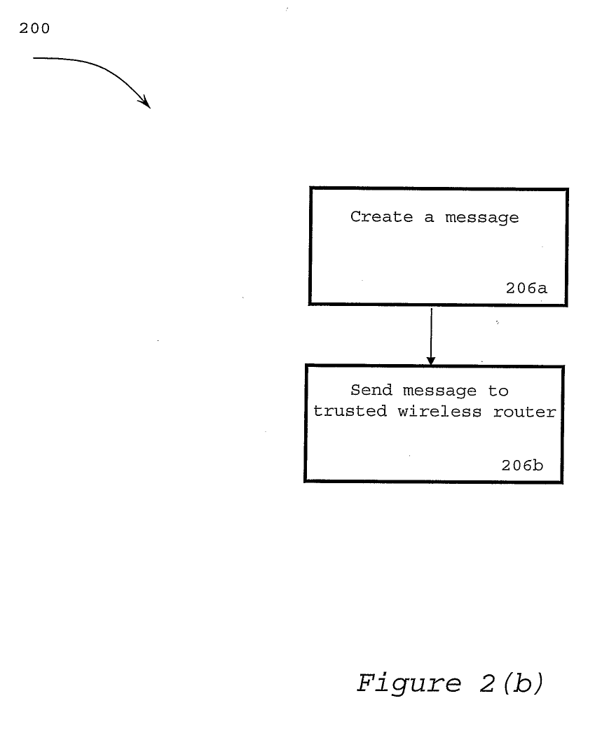

The wireless routers/switches 120 of the secondary network access points 106 and the user computing devices 110 comprises software that enables the wireless routers/switches 120 and the user computing devices 110 to interact with each other according to a ‘handoff’ procedure. The software is such that the handoff procedure is performed when a user computing device 110 moves out of radio range of one of the wireless routers/switches 120 and into radio range of another of the wireless routers/switches 120. The various steps performed during the handoff procedure are shown in the flow charts 200, 500 and 600 of FIGS. 2(a) to 2(c), FIG. 5 and FIG. 6.

It is noted that the various steps performed during the handoff procedure are performed subsequent to a user computing device 110 successfully undergoing a full IEEE 802.1X port-based authentication Full IEEE 802.1X port-based authentication is performed when a user computing device 110 initially connects to any one of the wireless routers/switches 120 of the secondary network access points 106. As persons skilled in the art will readily appreciate the full IEEE 802.1X port-based authentication involves using the Extensible Authentication Protocol (EAP) over Transport Layer Security (TLS). Consequently, full IEEE 802.1X port-based authentication involves a round of messages being exchanged between a user computing device 110 and the server 114 of a primary access point 104. In this regard, the server 114 operates as an Authentication, Authorisation and Accounting (AAA) server. It is noted that in an alternative embodiment of the present invention the AAA functionality may be performed by another computer server that forms part of the computer network 102.

In addition to the round of messages exchanged between the user computing device 110 and the server 114, full IEEE 802.1X port-based authentication involves the user computing device 110 and a wireless router/switch 120 of the secondary access point 106 undertaking a four-way handshake protocol. The four-way handshake protocol essentially enables the user computing device 110 to obtain at least one cryptographic key, which is subsequently used by the user computing device 110 and the wireless router/switch 120 to establish a secure communication link between each other; that is, using the cryptographic key to encrypt data exchanged between each other over the wireless link.

With reference to FIG. 2(a), the first step 202 that is performed by a wireless router/switch 120 during the handoff procedure is to obtain the cryptographic key. The wireless router/switch 120 obtains the cryptographic key by participating in the aforementioned four-way handshake protocol that is performed by a user computing device 110 and the wireless router/switch 120. Following on from the first step 202, the wireless router/switch 120 carries out the step 204 of identifying at least one trusted wireless router/switch 120. To identify the trusted wireless routers/switches 120 each wireless router is arranged to examine an internal electronic record that identifies the trusted wireless routers/switches 120. The internal electronic record can be populated and/or updated by the associated owner (administrator) of each wireless router/switch 120. The owner can set the internal electronic record such that it identifies only those wireless routers/switches 120 that are controlled by persons known (trusted) by the administrator. Thus, if for instance the owner of wireless router/switch 120a has a personal or business relationship with the owners of wireless routers/switches 120b and 120c the internal electronic record of wireless router/switch 120a would be set to identify wireless routers/switches 120b and 120c. It will be readily appreciated by those skilled in the art that the present invention is not restricted to the situation where the internal electronic record is populated and/or updated by the associated owner of the wireless router/switch 120. For example, it is envisaged that the internal electronic record could be populated and/or updated by a remote entity such as an Internet Service Provider (ISP). In this regard, the computer system operated by the ISP could remotely access a wireless router/switch 120 and update the internal electronic record.

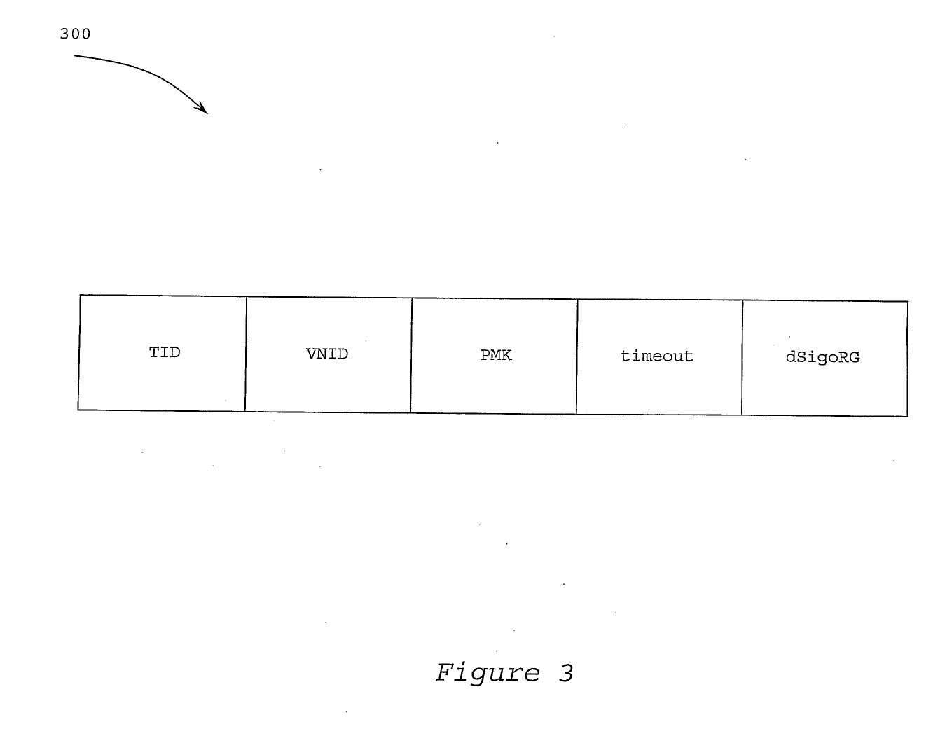

After performing the step 204 of identifying at least one trusted wireless router/switch 120, each wireless router/switch 120 is arranged to perform the step 206 of sending the cryptographic key (which was obtained during an earlier step 202) to the trusted wireless routers/switches 120 (which were identified during the previous step 204). The step 206 of sending the cryptographic key involves two sub-steps 206a and 206b, which are illustrated in the flow chart 200 of FIG. 2(b). The first 206a of the sub-steps involves creating a message 300 (a datum), which is depicted in FIG. 3. The message 300 comprises the fields {TID, VIND, PMK, timeout, dSigoRG}, where TID is a unique identifier of a ‘ticket’ (an other datum) that is issued to a user computing device 110, VNID is an unique identifier of the user computer device 110 (which, for example, could be the IP address assigned to the device 110), PMK is the cryptographic key obtained during an earlier step 202, timeout represents the time at which the message 300 expires, and dSigoRG is a digital signature for the wireless router/switch 120 creating the message.

After performing the sub-step 206a the wireless router/switch 120 is arranged to perform the second sub-step 206b of sending the message 300 to the trusted wireless routers/switches 120, to thereby send the cryptographic key to the trusted wireless routers/switches 120. To send the message 300 to the trusted wireless routers the sub-step 206b involves sending the message 300 to the trusted wireless routers/switches 120 via one or more secure links. The secure links are supported by the IPsec standard.

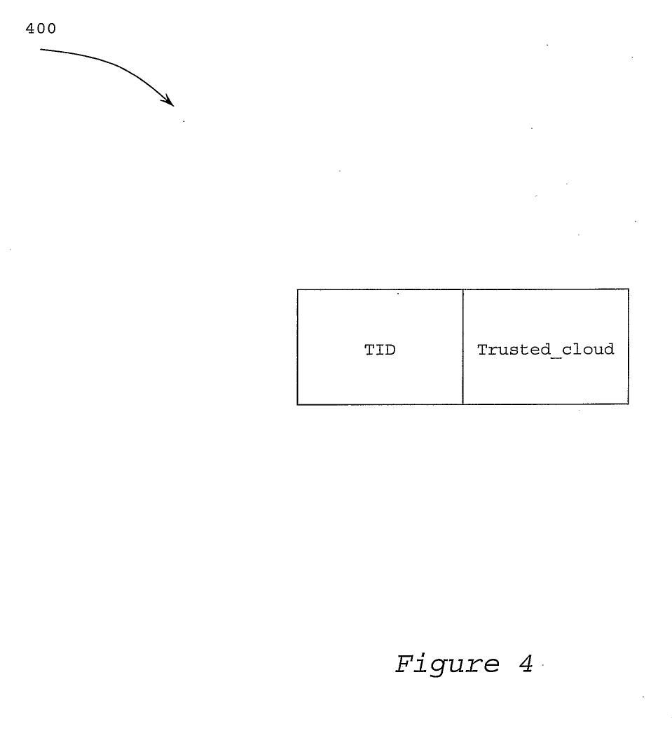

Each wireless router/switch 120 is also arranged to perform the step 208 of obtaining another message 400 (a datum), which is depicted in FIG. 4 and is the aforementioned “ticket”. The message 400 comprises the fields {TID, trusted_cloud}, where TID is the unique identifier of the message 400 and trusted_cloud is the list of trusted wireless routers/switches 120 identified in the internal record of trusted wireless routers/switches 120. The step 208 of obtaining the message comprises the sub-step 208a, which is depicted in FIG. 2(c), of processing: the unique identifier of a user computing device 110 (which as described previously could be the IP address of the device 110); the unique identifier of the wireless router/switch 120 performing the sub-step 208a (also referred to as the ‘trusting computing device’); and a timestamp. The information processed during the sub-step 208a is processed to obtain the TID.

Following on from the last step 208 a wireless routing/switching device 120 performs the step 210 of sending the message 400 to a user computing device 110. In order to send the message 400 to the user computing device the wireless router/switch 120 uses a secure communication link, which as mentioned previously is supported by the cryptographic key. As described in subsequent paragraphs of this specification the message 400 is used by the user computing device 110 when changing from one wireless router/switch 120 to another wireless router/switch 120.

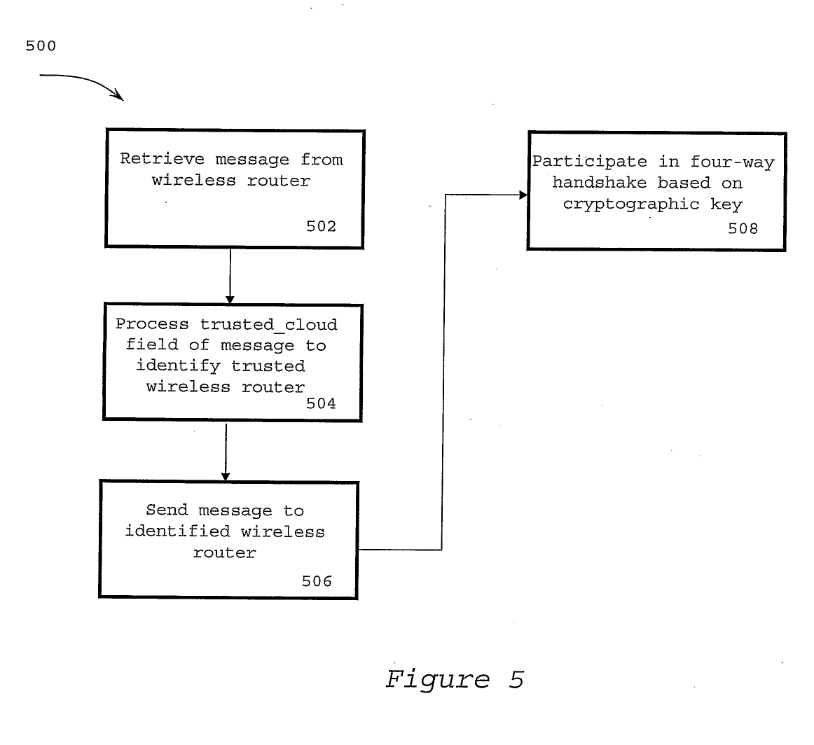

With reference to the flow chart 500 of FIG. 5, each user computing device 110 is arranged to perform various steps when performing the hand-off procedure. The initial step 502 performed by a user computing device 110 is to receive the message 400 from a wireless router/switch 120. As indicated previously in relation to a step 210 performed by a wireless router/switch 120, the message 400 is received via a secure link. The next step 504 performed by the wireless router/switch 120 is to process the trusted_cloud field of the message 400 in order to identify one or more trusted routers/switches 120 that are trusted by the wireless router/switch 120 that sent the message 400. Once the trusted routers/switches 120 have been identified the wireless router/switch 120 proceeds to carry out the step of 504 of identifying one of the trusted wireless routers/switches 120 (identified in trusted_cloud) that is lightly loaded; that is, a trusted wireless router/switch 120 that has a relative low resource (for example, CPU) load.

Once a lightly loaded trusted wireless router/switch 120 has been selected, the user computing device 110 performs the step 506 of sending, via a wireless link 112, the message 400 to the lightly loaded wireless router/switch 120. As described in more detail in subsequent paragraphs of this specification, the result of sending the message 400 to the lightly loaded wireless router/switch 120 is that the router/switch will respond by instructing the four-way handshake with the user computing device 110 based on the cryptographic key. Consequently, the user computing device 110 is arranged to perform the step 508 of participating in the four-way handshake procedure of the IEEE 802.1i port-based authentication procedure.

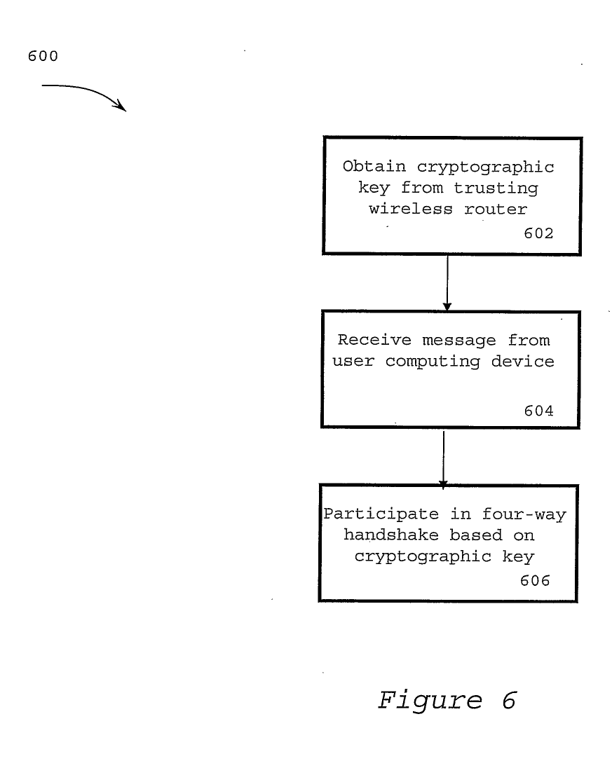

In view of the foregoing, each wireless routing/switching device 120 that is trusted by another wireless routing/switching device 120 is arranged to perform the various step contained in the flow chart 600 of FIG. 6. The initial step 602 of the steps is to obtain the cryptographic key from a wireless router/switch 120 (trusting wireless router) that trusts the wireless router/switch attempting to obtain the cryptographic key. The step 602 of obtaining the cryptographic key essentially involves extracting the cryptographic key from the message 300. In addition to the previous step 602 a trusting wireless router is arranged to perform the step 604 of receiving the message 400 from a user computing device 110. On receiving the message 400, the trusting wireless router/switch 120 responds by performing the step 606 of participating in the IEEE 802.1X port-based authentication, based on the cryptographic key, to authenticate the user computing device 110.

Persons skilled in the art will readily appreciate that even though the embodiment of the present invention has been described with reference to IEEE 802.11, the present invention is not restricted to IEEE 802.11 and can in fact be used in relation to other wireless networking technologies.

1. A method of facilitating secure communication, the method comprising the steps of:
obtaining a cryptographic key;
accessing an electronic record to identify at least one trusted computing device; and
sending the cryptographic key to the trusted computing device.

2. The method as claimed in claim 1, further comprising the steps of:
obtaining a first datum; and
sending the first datum to a user computing device that is arranged to send the first datum to the trusted computing device in order to obtain the cryptographic key therefrom.

3. The method as claimed in claim 2, wherein the first datum comprises:
an identifier of the first datum; and
an identifier of the trusted computing device.

4. The method as claimed in claim 3, wherein the step of obtaining the first datum comprises the step of processing an identifier of the user computing device, an identifier of a trusting computing device, and a timestamp in order to obtain the identifier of the first datum.

5. The method as claimed in claim 4, wherein the step of sending the first datum comprises the step of using a first secure link to send the first datum to the user computing device.

6. The method as claimed in claim 5, wherein the-step of obtaining the cryptographic key comprises the step of communicating with an authenticating computing device to obtain the cryptographic key.

7. The method as claimed in claim 6, wherein the step of sending the cryptographic key comprises the steps of:
obtaining a second datum that comprises: the identifier of the first datum; the identifier of the user computing device; the cryptographic key; and a digital signature of the trusting computing device; and
sending the second datum to the trusted computing device.

8. The method as claimed in claim 7, wherein the step of sending the second datum comprises the step of encrypting the second datum.

9. The method as claimed in claim 8, wherein the method further comprises the step of sending the cryptographic key to the user computing device in accordance with a predetermined protocol.

10. The method as claimed in claim 9, wherein the trusted computing device and the trusting computing device are each in the form of a wireless router/switch.

11. A method of facilitating secure communication, the method comprising the steps of:
Accessing an electronic record to identify a trusted computing device;
obtaining a cryptographic key from a trusting computing device;
receiving a first datum from a user computing device; and
sending the cryptographic key to the user computing device in response to receiving the first datum.

12. The method as claimed in claim 11, wherein the step of obtaining the cryptographic key comprises the steps of:
receiving from the trusting computing device a second datum that comprises: an identifier of the first datum; an identifier of the user computing device; the cryptographic key; and a digital signature of the trusting computer, and
retrieving the cryptographic key from the second datum.

13. The method as claimed in claim 12, wherein the step of receiving from the trusting computing device comprises the step of decrypting the second datum.

14. The method as claimed in claim 13, wherein the step of sending the cryptographic key comprises the step of sending the cryptographic key in accordance with a predetermined protocol.

15. The method as claimed in claim 14, wherein the first datum comprises:
an identifier of the first datum; and
an identifier of a trusted computing device.

16. The method as claimed in claim 15, wherein the trusted computing device and the trusting computing device are each in the form of a wireless router/switch.

17. A method of facilitating secure communication, the method comprising the steps of:
receiving a first datum from a trusting computing device;
sending the first datum to a trusted computing device; and
receiving a cryptographic key from the trusted computing device in response to sending the first datum to the trusted computing device.

18. The method as claimed in claim 17, wherein the method further comprising the steps of:
determining a resource availability of the trusted computing device; and
performing the step of sending the first datum to the trusted computing device if it determined that the resource availability does not fall below a predetermined level.

19. The method as claimed in claim 18, wherein the step of receiving the first datum comprises the step of using a secure link to receive the first datum from the trusted computing device.

20. The method as claimed in claim 14, wherein the first datum comprises:
an identifier of the first datum; and
an identifier of the trusted computing device.

21. The method as claimed in claim 20, further comprising the step of processing the identifier of the trusted computing device in order to perform the step of sending the first datum to the trusted computing device.

22. The method as claimed in claim 21, wherein the step of receiving the cryptographic key comprises the step of receiving the cryptographic key in accordance with a predetermined protocol.

23. The method as claimed in claim 22, wherein the trusted computing device and the trusting computing device are each in the form of a wireless router/switch.

24. A system for facilitating secure communication, the system comprising a processing means arranged to perform the steps of:
obtaining a cryptographic key;
accessing an electronic record to identify at least one trusted computing device; and
sending the cryptographic key to the trusted computing device.

25. The system as claimed in claim 24, wherein the processing means is further arranged to perform the steps of:
obtaining a first datum; and
sending the first datum to a user computing device that is arranged to send the first datum to the trusted computing device in order to obtain the cryptographic key therefrom.

26. The system as claimed in claim 25, wherein the first datum comprises:
an identifier of the first datum; and
an identifier of the trusted computing device.

27. The system as claimed in claim 26, wherein the processing means is arranged such that the step of obtaining the first datum comprises the step of processing an identifier of the user computing device, an identifier of a trusting computing device, and a timestamp in order to obtain the identifier of the first datum.

28. The system as claimed in claim 27, wherein the processing means is arranged such that the step of sending the first datum comprises the step of using a first secure link to send the first datum to the user computing device.

29. The system as claimed in claim 28, wherein the processing means is arranged such that the step of obtaining the cryptographic key comprises the step of communicating with an authenticating computing device to obtain the cryptographic key.

30. The system as claimed in claim 29, wherein the processing means is arranged such that the step of sending the cryptographic key comprises the steps of:
obtaining a second datum that comprises: the identifier of the first datum; the identifier of the user computing device; the cryptographic key; and a digital signature of the trusting computing device; and
sending the second datum to the trusted computing device.

31. The system as claimed in claim 30, wherein the processing means is arranged such that the step of sending the second datum comprises the step of encrypting the second datum.

32. The system as claimed in claim 31, wherein the processing means is further arranged to perform the step of sending the cryptographic key to the user computing device in accordance with a predetermined protocol.

33. The system as claimed in claim 32, wherein the trusted computing device and the trusting computing device are each in the form of a wireless router/switch.

34. A system for facilitating secure communication, the system comprising a processing means arranged to perform the steps of:
accessing an electronic record to identify a trusted computing device;
obtaining a cryptographic key from the trusted computing device;
receiving a first datum from a user computing device; and
sending the cryptographic key to the user computing device in response to receiving the first datum.

35. The system as claimed in claim 34, wherein the processing means is arranged such that the step of obtaining the cryptographic key comprises the steps of:
receiving from the trusting computing device a second datum that comprises: an identifier of the first datum; an identifier of the user computing device; the cryptographic key; and a digital signature of the trusting computer; and
retrieving the cryptographic key from the second datum.

36. The system as claimed in claim 35, wherein the processing means is arranged such that the step of receiving from the trusting computing device comprises the step of decrypting the second datum.

37. The system as claimed in claim 36, wherein the processing means is arranged such that the step of sending the cryptographic key comprises the step of sending the cryptographic key in accordance with a predetermined protocol.

38. The system as claimed in claim 37, wherein the first datum comprises:
an identifier of the first datum; and
an identifier of a trusted computing device.

39. The system as claimed in claim 38, wherein the trusted computing device and the trusting computing device are each in the form of a wireless router/switch.

40. A system for facilitating secure communication, the system comprising a processing means arranged to perform the steps of:
receiving a first datum from a trusting computing device;
sending the first datum to a trusted computing device; and
receiving a cryptographic key from the trusted computing device in response to sending the first datum to the trusted computing device.

41. The system as claimed in claim 40, wherein the processing means is further arranged to perform the steps of:
determining a resource availability of the trusted computing device; and
performing the step of sending the first datum to the trusted computing device if it determined that the resource availability does not fall below a predetermined level.

42. The system as claimed in claim 41, wherein the processing means is arranged such that the step of receiving the first datum comprises the step of using a secure link to receive the first datum from the trusted computing device.

43. The system as claimed in claim 42, wherein the first datum comprises:
an identifier of the first datum; and
an identifier of the trusted computing device.

44. The system as claimed in claim 43, wherein the processing means is further arranged to perform the step of processing the identifier of the trusted computing device in order to perform the step of sending the first datum to the trusted computing device.

45. The system as claimed in claim 44, wherein the processing means is arranged such that the step of receiving the cryptographic key comprises the step of receiving the cryptographic key in accordance with a predetermined protocol.

46. The system as claimed in claim 45, wherein the trusted computing device and the trusting computing device are each in the form of a wireless router/switch.

47. (canceled)

48. (canceled)
